(19) United States
(12) Patent Application Publication
(10) Pub. No.: US 2005/0152330 A1
(43) Pub. Date: Jul. 14, 2005

(54) Clock recovery methods and apparatus

(76) Inventors: Adrian P. Stephens, Cottenham (GB); Dmitrii Loukianov, Chandler, AZ (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/815,563

(22) Filed: Mar. 31, 2004

Related U.S. Application Data
(60) Provisional application No. 60/536,071, filed on Jan. 12, 2004.

(51) Int. Cl. H04L 12/56; H04J 3/06

(52) U.S. Cl. 370/350; 370/503; 370/395.62

(57) ABSTRACT

A source application executed within a source device may packetize and send source data over a link to a destination application executed within a destination device. In various embodiments, clock recovery processes are performed in conjunction with the destination application in order to synchronize the rates of source data production and consumption (e.g., playback). To facilitate the clock recovery process, a transport delay is calculated based on the difference between a source MAC-layer timestamp and a destination MAC-layer timestamp that envelop portions of the link that include variable delay elements. The transport delay is used by the clock recovery process to adjust a source application-layer timestamp, in one embodiment. In another embodiment, the transport delay is used by the destination device to impart a fixed cumulative transport delay on the source data before it is delivered to the destination application.

### RELATED APPLICATION

This application claims priority to U.S. Provisional Application No. 60/536,071, filed on Jan. 12, 2004.

### TECHNICAL FIELD

The inventive subject matter pertains to methods and apparatus to recover an application clock associated with a communications packet, and more particularly, to methods and apparatus to recover an application clock for packets that are sent from a source application to a destination application through a variable-delay channel.

### BACKGROUND

Various types of applications produce time-sensitive content. For example, a multi-media application executed by a source device may produce video and audio content at a particular rate. In some systems, the application data is transmitted over a link to a destination device (e.g., a computer or television), and the destination device plays back or otherwise consumes the application data. Desirably, the destination device will consume the application data at substantially the same rate as the rate at which the data was produced. In systems with a unidirectional link and in systems in which the source device contends for access to shared system resources, it becomes more challenging to synchronize data production and consumption while maintaining an acceptable quality of service.

### BRIEF DESCRIPTION OF THE DRAWINGS

The appended claims point out different embodiments of the inventive subject matter with particularity. However, the detailed description presents a more complete understanding of the inventive subject matter when considered in connection with the figures, wherein like-reference numbers refer to similar items throughout the figures and:

FIG. 1 is a simplified block diagram of two wireless local area network configurations, in accordance with embodiments of the inventive subject matter;

FIG. 2 is a simplified block diagram of a communication device, in accordance with an embodiment of the inventive subject matter;

FIG. 3 is a simplified block diagram illustrating packet flow from a source application to a destination application, in accordance with an embodiment of the inventive subject matter;

FIG. 4 is a flowchart of a method for performing clock recovery in a system such as that illustrated in FIG. 3, in accordance with an embodiment of the inventive subject matter;

FIG. 5 is a simplified block diagram illustrating packet flow from a source application to a destination application, in accordance with another embodiment of the inventive subject matter;

FIG. 6 is a flowchart of a method for performing clock recovery in a system such as that illustrated in FIG. 5, in accordance with an embodiment of the inventive subject matter;

FIG. 7 is a simplified block diagram illustrating packet flow from a source application to a destination application, in accordance with another embodiment of the inventive subject matter;

FIG. 8 is a flowchart of a method for performing clock recovery in a system such as that illustrated in FIG. 7, in accordance with an embodiment of the inventive subject matter;

FIG. 9 is a simplified block diagram illustrating packet flow from a source application to a destination application, in accordance with another embodiment of the inventive subject matter;

FIG. 10 is a flowchart of a method for performing clock recovery in a system such as that illustrated in FIG. 9, in accordance with an embodiment of the inventive subject matter;

FIG. 11 is a simplified block diagram of a source medium access control device, in accordance with an embodiment of the inventive subject matter; and

FIG. 12 is a simplified block diagram of a destination medium access control device, in accordance with another embodiment of the inventive subject matter.

### DETAILED DESCRIPTION

In the following description of various embodiments, reference is made to the accompanying drawings, which form a part hereof and show, by way of illustration, specific embodiments in which the inventive subject matter may be practiced. Various embodiments are described in sufficient detail to enable those skilled in the art to practice the inventive subject matter. It is to be understood that other embodiments may be utilized, and that process or mechanical changes may be made, without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed. It will be recognized that the methods of various embodiments can be combined in practice, either concurrently or in succession. Various permutations and combinations will be readily apparent to those skilled in the art.

Embodiments of the inventive subject matter may be implemented in a number of different types of systems. For example, but not by way of limitation, embodiments may be implemented in a system within which a satellite transmitter (i.e., a source device) broadcasts synchronized program content toward a population of destination devices (e.g., satellite receivers and televisions). As another example, embodiments may be implemented in a computer network, within which an application executed at a source device (e.g., a server, an access point, router, or another device) produces streaming video and audio, which is delivered over one or more channels to one or more destination computers that replay the content. Types of systems in which embodiments may be implemented include, but are not limited to, satellite networks, wired or wireless telephone networks, and wired or wireless computer networks (e.g., the Internet, local area networks, wide area networks, etc.), to name a few. Embodiments of the inventive subject matter can be implemented in systems in which application packets are broadcast and/or networks in which application packets are addressed to one or more specific destination devices.

A generic description of a system in which embodiments may be implemented includes one or more source devices and one or more destination devices. Both the source and destination devices include an application clock associated with the source application and the destination application, respectively. The source application clock is used to timestamp segments of packetized data, and the destination application clock is used to control the rate of data playback or consumption. In one embodiment, the source device contends for access to shared system resources. Accordingly, the source device's transmission interface may be required to delay transmission of the application packets by a variable amount of time.

As will be described later, both the source and destination devices also include another clock, referred to herein as a “substantially synchronized clock,” which is associated with each the device's network interface. Timestamps generated from the substantially synchronized clocks are used to account for the variations in delay that may occur as a result of network contention, routing, and/or other delay-producing factors. These inventive concepts will be described in detail below, using various example systems and device configurations to illustrate application of the concepts.

For example, but not by way of limitation, embodiments may be implemented in a wireless local area network (WLAN). Example WLAN configurations are described below in order to illustrate a specific application of various embodiments. The below examples are not meant to limit the scope of the inventive subject matter to application within a WLAN. Instead, as would be obvious to one of skill in the art based on the description herein, embodiments could be implemented in a number of different types of systems in which a source application produces time-sensitive data or data sensitive to delay variability for consumption by a remote destination application.

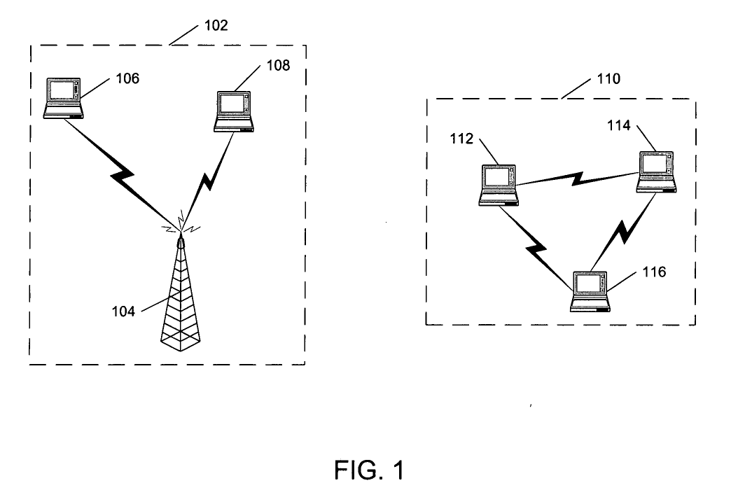

FIG. 1 is a simplified block diagram of two WLAN configurations 102, 110, in accordance with embodiments of the inventive subject matter. A WLAN may include multiple network stations 106, 108, 112, 114, 116 and zero or more access points (APs) 104.

In a WLAN, network stations 106, 108, 112, 114, 116 communicate over the medium of free space, commonly referred to as the “air interface.” Generally, a station 106, 108, 112, 114, 116 may be referred to as a network adapter or network interface card (NIC). A station 106, 108, 112, 114, 116 may be mobile, portable or stationary. For example, a station 106, 108, 112, 114, 116 may include a laptop computer, a handheld radio, a desktop computer, an audio and/or video recorder, an audio and/or video player, or virtually any other one-way or two-way device with the capability of communicating with other devices 106, 108, 112, 114, 116 or APs 104 over a wireless medium.

A set of stations 112, 114, 116 may communicate directly with each other, as is the case in a Basic Service Set (BSS). An Independent BSS (IBSS) 110 is a BSS in which there is no connection to a wired network.

An infrastructure BSS 102 is a WLAN configuration that includes an AP 104. In an infrastructure BSS, all stations 106, 108 communicate with an AP 104. The AP 104 provides the connection to a wired LAN, if any, and the local relay function for the BSS. Accordingly, if a first station 106 wants to communicate with a second station 108, the first station 106 sends the communication to the AP 104, and the AP 104 relays the communication to the second station 108. Infrastructure BSS stations 106, 108 may also communicate directly with each other using a direct link protocol.

An Extended Service Set (ESS) is a set of infrastructure BSSs, where the APs communicate among themselves to forward traffic from one BSS to another, and to facilitate the movement of stations from one BSS to another. The Distribution System (DS) is a mechanism by which one AP communicates with another to exchange frames from stations in their BSSs, forward frames to follow mobile stations from one BSS to another, and exchange frames with wired or wireless distribution networks, if any. Embodiments of the inventive subject matter could be included in any of the above-described types of WLAN systems, as well as in other wired or wireless network systems.

Embodiments of the invention will now be described in more detail. Although various embodiments are described in detail, below, using terms that are similar to terms used in the context of an IEEE 802.11 Standard (e.g., IEEE Std 802.11-1997, 802.11a, 802.11e, etc.), the invention is not meant to be limited to use within a system that uses an IEEE 802.11 Standard. Instead, embodiments of the invention could be used in conjunction with other network standards, as well.

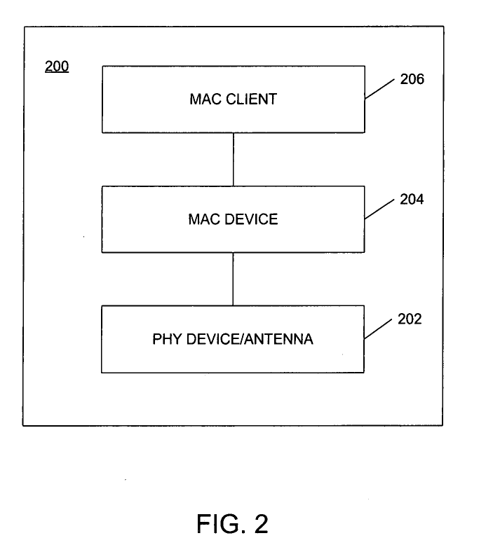

FIG. 2 is a simplified block diagram of a communication device 200, in accordance with an embodiment of the inventive subject matter. In one embodiment, device 200 is a WLAN device. However, in other embodiments, device 200 could be any of a number of other types of wireless devices (e.g., cellular telephones, radios, pagers, personal data assistants, global positioning system (GPS) devices, satellite transmitters and receivers, access points, base stations, etc.), or other devices that may communicate over a network.

Any WLAN device that supports an Institute of Electrical and Electronics Engineers (IEEE) 802.11 Standard (e.g., IEEE Std 802.11-1997, 802.11a, 802.11e, etc.) includes several main parts: 1) a physical (PHY) layer signaling control device 202; 2) a medium access control (MAC) device 204; and 3) a MAC client 206. WLAN station 200 supports station services, which are provided by PHY device 202 and MAC device 204, and used by MAC client 206. These services may include, for example, authentication, deauthentication, privacy, and delivery of data.

One purpose of the PHY device 202 and the MAC device 204 is to ensure that two network stations are communicating with the correct frame format and protocol. In some systems, an EEE Std 802.11 defines the communication protocol between the PHY and MAC devices 202, 204.

The function of the PHY device 202 is threefold: 1) to provide a frame exchange between the MAC 204 and PHY 202; 2) to transmit data frames over the air interface; and 3) to provide a carrier sense indication back to the MAC 204 so that the MAC 204 is able to detect activity on the air interface.

The PHY device 202 implements one of several physical layer specifications, such as infrared (IR) baseband, frequency hopping spread spectrum (FHSS), direct sequence spread spectrum (DSSS), orthogonal frequency domain multiplexing (OFDM), or multiple-in multiple-out (MIMO) specifications (i.e., multiple antenna), for example. Other specifications can be implemented in other embodiments.

The PHY device 202 may include various components for converting, formatting, and transmitting a packet over the air interface. Each of these components may or may not use some or all of the same physical circuitry (e.g., processors, busses, clocks, storage, etc.). In addition, one or more antennas (not shown) may be included in association with PHY device 202. When an IR baseband specification is implemented, a light-emitting diode (LED) (not shown) or other optical transmission device may be used instead of an antenna.

The MAC device 204 provides an interface between the MAC client 206 and the PHY device 202. Among other things, the function of the MAC device 204 is to control access to the shared air interface. In addition, the MAC device 204 may or may not perform encryption and decryption. In one embodiment, the MAC device supports the MAC sublayer according to an IEEE Std 802.11 standard. In other embodiments, the MAC device supports the MAC sublayer according to another standard.

The MAC client 206 includes one or more applications, in one embodiment, which may create, process, and/or transfer data, among other things. Some of these applications may produce packets of source application data (referred to herein as “application-layer packets”), which are intended for consumption by a destination application located elsewhere in the system. Source data may include, for example, media data such as compressed or uncompressed audio and/or video data. Source data may also include other types of time-sensitive or rate-sensitive data, as well.

Data that is sent from a source application to a destination application may be subjected to several packetizing operations. In one embodiment, the source application first packetizes the source data within a source application-layer packet. The source application-layer packet includes a source application-layer packet header and a data segment with the source data.

The application-layer packet is received by the source device's MAC device, which produces a MAC packet that includes a MAC-layer header and the source application-layer packet. The MAC device contends for access to the system, and sends the MAC packet, via the source device's PHY device, onto the transmission medium.

The destination device's PHY device receives the MAC packet and passes it to the destination device's MAC device. In some embodiments, the destination device's MAC device may delay data delivery so that the MAC device will deliver the data in a proper order (e.g., if the MAC layer uses a selective acknowledgement scheme, such as an IEEE 802.11e Block Ack feature). The MAC device processes the MAC packet and produces a destination application-layer packet. The destination application-layer packet includes the source data. In addition, in one embodiment, the destination application-layer packet includes information from the source application-layer packet header. The destination application-layer packet header may also include other information, in various embodiments. In accordance with various embodiments, described in detail below, the destination application performs clock recovery using information within the destination application-layer packet.

As mentioned above, each application-layer packet includes a header and a data segment, in one embodiment. The application-layer packet header, and/or the MAC-layer packet header, and/or other packet fields may be used to convey time-based information (e.g., timestamps) that enable a destination device to substantially compensate for delays caused by various device and system elements that are operationally situated between the source application and the destination application. These device and system elements may include, for example, one or more MAC device delay or processing elements (e.g., associated with MAC device 204), one or more PHY device delay or processing elements (e.g., PHY device 202), one or more data buffers, the transmission medium (e.g., wired or wireless mediums), and other elements.

Significant variations may occur in the delays imposed by some device and system elements. Other elements may not experience significant variations in the delays that they impose. Various embodiments of the inventive subject matter, described in detail below, include techniques and apparatus for performing clock recovery to substantially compensate for delays and delay variances that may be imposed by device and system elements between a source application and a destination application.

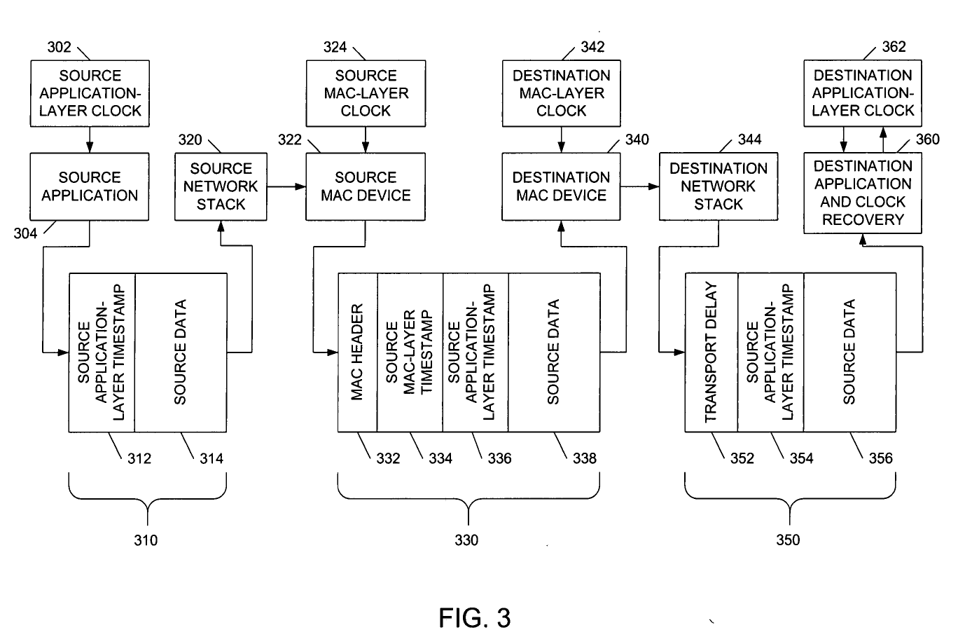

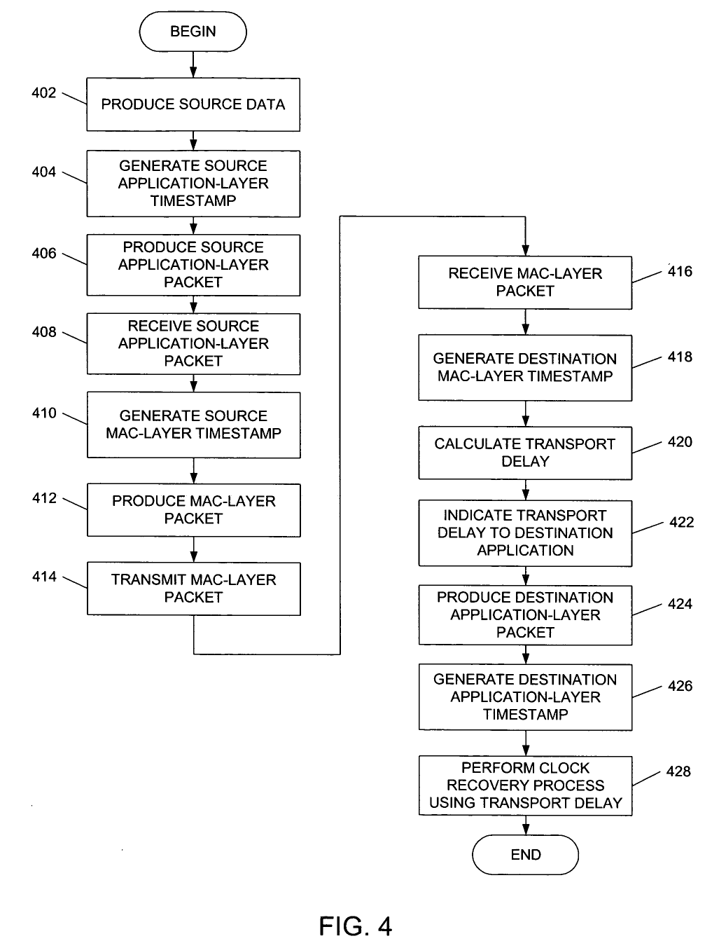

FIG. 3 is a simplified block diagram illustrating packet flow from a source application to a destination application, in accordance with an embodiment of the inventive subject matter. FIG. 3 should be viewed in conjunction with FIG. 4, which is a flowchart of a method for performing clock recovery in a system such as that illustrated in FIG. 3, in accordance with an embodiment of the inventive subject matter.

FIG. 3 will be described from left to right, and descriptions of the various method operations of FIG. 4 will be intertwined with the descriptions of the elements of FIG. 3 and, accordingly, it is suggested that FIGS. 3 and 4 be viewed side-by-side for greater understanding. Also, to aid the reader in following the description, it is noted that elements of FIG. 3 are referred to with reference numerals starting with “3” (e.g., 302, 304, etc.), and operations of FIG. 4 are referred to with reference to numerals starting with “4” (e.g., 402, 404, etc.).

As described previously, a source device may execute one or more source applications, such as source application 304 (FIG. 3). Numerous types of source applications may be executed on a source device, including but not limited to voice processing applications, image processing applications, other data processing applications, encryption and decryption algorithms, encoding and decoding algorithms, compression and decompression algorithms, and many more. Source application 304 produces source data, in block 402 (FIG. 4).

Source application 304 has access to a source application-layer clock 302. In one embodiment, source application 304 generates a source application-layer timestamp, in block 404, by reading clock 302 at approximately a time when source application 304 produces an application-layer packet, in block 406 (i.e., a time when the source data leaves the application on its way to be transmitted over a device-to-device communication link). Application-layer clock 302 indicates time using a particular time base (e.g., milliseconds, microseconds, or the like).

An example of a source application-layer packet 310 is illustrated in FIG. 3. Packet 310 includes a source application-layer timestamp 312 and the source data 314, in one embodiment. The source application-layer timestamp 312 may form a portion of a source application-layer packet header, or timestamp 312 may be placed in a separate field from a header, in various embodiments. If the application-layer packet 310 includes a header, the header may contain fields with other information, as well. However, for ease of illustration, any other information that may be included in a header is omitted from FIG. 3.

The source application-layer packet 310 is passed through a source network stack 320. The source network stack 320 may include, for example but not by way of limitation, one or more processor stacks or other elements that exist within the interface between the application and a MAC device. Some or all of these stack elements may impose delays on the source application-layer packet 310.

In some devices, the cumulative delay imposed by the stack elements may be substantially the same (i.e., substantially constant) for each transmitted packet, or may vary so slowly with time that the network stack delays are not significant when compared with other network delays. This type of network stack is referred to herein as a “constant delay network stack.” In other devices, the cumulative delay imposed by the stack elements may vary significantly from packet to packet. This type of network stack is referred to herein as a “variable delay network stack.”

When the source application-layer packet 310 emerges from the source network stack 320, it is received by the source MAC device 322, in block 408. Source MAC device 322 has access to a source MAC-layer clock 324. In one embodiment, MAC device 322 generates a source MAC-layer timestamp, in block 410, by reading clock 324 at approximately a time when MAC device 322 receives the source application layer packet 310 (i.e., at the “top” of the MAC device 322, or when the packet 310 is received by the MAC layer).

In one embodiment, source MAC-layer clock 324 is a clock that is substantially synchronized with a counterpart MAC-layer clock 342 associated with a destination device (described below), and both of these clocks 324, 342 use the same time base (e.g., milliseconds, microseconds, or the like). The time base used by the MAC-layer clocks 324, 342 may be the same or different from the time base used by the source application-layer clock 302 (e.g., an IEEE 802.11 system may use a clock based on microseconds). For example, an MPEG (Motion Picture Expert's Group) video/audio program clock typically runs at 27 MegaHertz (MHz), but this clock may be “ported” over a wireless network based on the MAC clock of the wireless network running at 1 MHz, using an embodiment of the method.

Substantial synchronization can be achieved, for example, when the source and destination devices receive a timing beacon from an AP (e.g., in an infrastructure BSS), or when the source and destination devices synchronize their MAC-layer clocks with each other (e.g., in an independent BSS) (e.g., IEEE 802.11 systems typically maintain their clocks to within three microseconds).

As will be described in more detail later, a source MAC-layer timestamp that is generated from the source MAC-layer clock 324 is used, along with other information, for the purpose of performing clock recovery in the destination device. Theoretically, a timestamp could be produced using a different substantially synchronized clock than the source MAC-layer clock. The use of the term “MAC-layer timestamp” is not meant to limit the inventive subject matter to use only of a MAC-layer clock.

Source MAC device 322 produces a MAC packet 330, in block 412. An example of a MAC packet 330 is illustrated in FIG. 3. Packet 330 includes a MAC header 332, a source MAC-layer timestamp 334, the source application-layer timestamp 336 (from the application packet 310), and the source data 338 (also from the application packet 310), in one embodiment. The source MAC-layer timestamp 334 is shown as being distinct from MAC header 332, in FIG. 3. In another embodiment, the source MAC-layer timestamp 334 may form a portion of MAC header 332. MAC header 332 contains various fields of information. However, for ease of illustration, details regarding the MAC header fields are omitted from FIG. 3.

The MAC device 322 may delay transmission of the source data by a variable amount of time, primarily because the MAC device 322 may need to internally delay transmission until it is granted access to the wireless medium, or until the wireless medium is clear of other transmissions.

When that occurs, the source MAC device 322 passes the MAC packet 330 to a source PHY device (not illustrated in FIG. 3), which processes the MAC packet and transmits it over a device-to-device communication link, in block 414. If one or more bridges or routers exist between the source and destination devices, timestamping may need to be applied separately for each route segment. Embodiments of the inventive subject matter may be modified to account for communications through a bridged network, and all such embodiments are intended to be included within the scope of the inventive subject matter. For purposes of brevity and clarity, such embodiments are not discussed in detail herein.

Ultimately, the MAC packet 330 is received by a destination PHY device (not illustrated in FIG. 3), in block 416. The destination PHY device processes the MAC packet, and passes it to the destination MAC device 340. Destination MAC device 340 also may delay the MAC packet 330 by a variable amount of delay. However, unless selective acknowledgment is being used, this delay is likely much less significant that the delay imposed by the source MAC device 322.

Destination MAC device 340 has access to a destination MAC-layer clock 342. In one embodiment, MAC device 340 generates a destination MAC-layer timestamp, in block 416, by reading clock 342 at approximately a time when the information within the MAC packet 330 is ready to emerge from the MAC device 340 (i.e., it is being passed from the MAC device 340 to the destination network stack 344).

In one embodiment, destination MAC-layer clock 342 is a clock that is substantially synchronized with its counterpart MAC-layer clock 324 associated with the source device, as described previously. A destination MAC-layer timestamp that is generated, in block 418, from the destination MAC-layer clock 342. This timestamp is used for the purpose of improving clock recovery support, as will be described in the next paragraph. Theoretically, a timestamp could be produced using a different substantially synchronized clock than the destination MAC-layer clock. As mentioned previously, the use of the term “MAC-layer timestamp” is not meant to limit the inventive subject matter to use only of a MAC-layer clock.

In block 420, the MAC device 340 calculates a transport delay, in one embodiment. The transport delay is approximately equal to the time difference between the source MAC-layer timestamp and the destination MAC-layer timestamp. The transport delay represents an approximation of the delay imposed by system elements operationally situated between the source MAC device 322 and the destination MAC device 340.

In one embodiment, in block 422, the MAC device 340 indicates the transport delay to the destination application 360. In addition, the MAC device 340 produces a destination application-layer packet 350, in block 424. The destination application-layer packet 350 includes the transport delay indication 352, the source application-layer timestamp 354, and the source data 356, in one embodiment. In another embodiment, the transport delay indication 352 is not communicated to the destination application 360 within the destination application-layer packet, but is instead communicated separately to the destination application 360.

In another embodiment, the MAC device 340 indicates the source MAC-layer timestamp and the destination MAC-layer timestamp to the destination application 360, and the destination application calculates the transport delay. In such an embodiment, the destination application-layer packet 350 may include fields for the source and destination MAC-layer timestamps, rather than or in addition to the transport delay field 352.

The destination application-layer packet is passed from the destination MAC device 340 to the destination application 360 through a destination network stack 344, in one embodiment. Similar to the source network stack 320, the destination network stack 344 may include one or more processor stacks and/or other delay elements. The destination network stack 344 may be a constant delay network stack or a variable delay network stack, in various embodiments. Destination application 360 receives the destination application-layer packet 350, along with or separately from the transport delay indication 352.

Destination application 360 includes a clock recovery process, in one embodiment. Destination application 360 also has access to a destination application-layer clock 362. Destination application-layer clock 362 indicates time using a particular time base (e.g., milliseconds, microseconds, or the like), which may be the same time base that is used by source application-layer clock 302. In one embodiment, destination application 360 generates a destination application-layer timestamp, in block 426, by reading clock 362 at approximately a time when destination application 360 receives the destination application-layer packet.

The destination application 360 then performs a clock recovery process, in block 428. In one embodiment, the clock recovery process 360 includes adjusting the source application-layer timestamp with the indicated transport delay before using the source application-layer timestamp for application clock recovery. In one embodiment, clock recovery process 360 subtracts the transport delay from the source application-layer timestamp. Clock recovery process 360 then compares the adjusted source application-layer timestamp with the destination application-layer timestamp, calculates the difference between the two values, and adjusts the destination application-layer clock 362 according to the calculated difference. In one embodiment, the clock recovery process 360 includes a phase lock loop and one or more filters, which enable the process 360 to avoid jittering the destination application-layer clock 362 unacceptably, but instead to make relatively smooth clock adjustments.

The clock recovery process described above enables the destination application 360 to extract and consume (e.g., play back) the source data in rate-synchronization with the source application, without the quality of service being substantially affected by variability in the cumulative transmission delay. The method then ends.

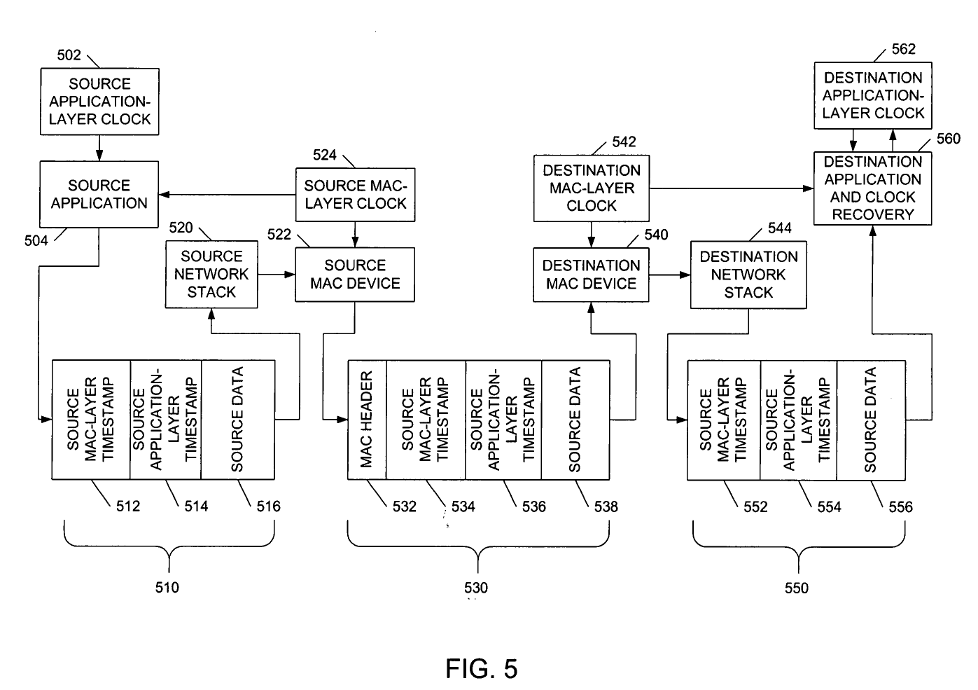

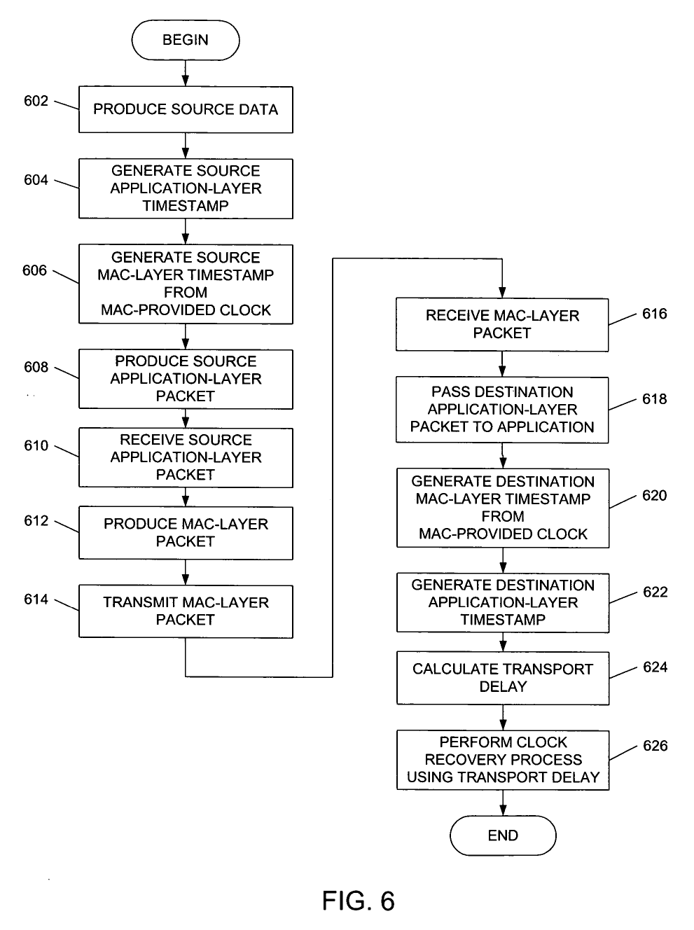

The embodiments described above in conjunction with FIGS. 3 and 4 generate the MAC-layer timestamp (e.g., timestamp 334) when the source data enters the MAC layer. As described previously, the source network stack (e.g., stack 320) may impose a variable delay in addition to the delay caused by other device and system elements. Accordingly, in another embodiment, the MAC-layer timestamp is generated approximately when the source data enters the source network stack, rather than when the source data enters the MAC layer. This embodiment is described in conjunction with FIGS. 5 and 6.

FIG. 5 is a simplified block diagram illustrating packet flow from a source application to a destination application, in accordance with another embodiment of the inventive subject matter. FIG. 5 should be viewed in conjunction with FIG. 6, which is a flowchart of a method for performing clock recovery in a system such as that illustrated in FIG. 5, in accordance with an embodiment of the inventive subject matter.

FIG. 5 will be described from left to right, and descriptions of the various method operations of FIG. 6 will be intertwined with the descriptions of the elements of FIG. 5 and, accordingly, it is suggested that FIGS. 5 and 6 be viewed side-by-side for greater understanding. Also, to aid the reader in following the description, it is noted that elements of FIG. 5 are referred to with reference numerals starting with “5” (e.g., 502, 504, etc.), and operations of FIG. 6 are referred to with reference to numerals starting with “6” (e.g., 602, 604, etc.). Several of the elements and operations of FIGS. 5 and 6 are similar to elements and operations described in conjunction with FIGS. 3 and 4. Where similarities exist, they will not be extensively repeated for the purposes of brevity.

A source device may execute one or more source applications, such as source application 504 (FIG. 5). Source application 504 produces source data, in block 602 (FIG. 6).

Source application 504 has access to a source application-layer clock 502. In one embodiment, source application 504 generates a source application-layer timestamp, in block 604, by reading clock 502 at approximately a time when source application 504 produces an application-layer packet.

In addition, in one embodiment, source application 504 has access to a source MAC-layer clock 524 through an interface between the application layer and the MAC layer. In one embodiment, source application 504 also generates a source transport (e.g., MAC-layer) timestamp, in block 606, by reading clock 524 at approximately a time when source application 504 submits the source data to the source network stack 520. In one embodiment, source application 504 generates the source MAC-layer timestamp using the same time base as the source MAC-layer clock 524. In another embodiment, source application 504 generates the source MAC-layer timestamp by converting the time reading from the MAC-layer clock 524 into the same time base that is used for the source application-layer clock 502.

Source application 504 produces a source application-layer packet, in block 608. An example of a source application-layer packet 510 is illustrated in FIG. 5. Packet 510 includes a source MAC-layer timestamp 512, a source application-layer timestamp 514, and the source data 516, in one embodiment. The source MAC-layer timestamp 512 and/or the source application-layer timestamp 514 may form portions of a source application-layer packet header, or timestamps 512 and/or 514 may be placed in separate fields from a header, in various embodiments. If the application-layer packet 510 includes a header, the header may contain fields with other information, as well. However, for ease of illustration, any other information that may be included in a header is omitted from FIG. 5.

The source application-layer packet 510 is passed through a source network stack 520, which includes stack elements that may or may not impose significant delays on the source application-layer packet 510. By generating the source MAC-layer timestamp 512 before the packet 510 incurs these delays, the destination application 560 will be able to subtract off these delays prior to performing clock recovery, as will be described later. Accordingly, the embodiments described in conjunction with FIGS. 5 and 6 enable the calculated transport delay to encompass more system delay elements that may cause variable delays between the source application and the destination application. Accordingly, these embodiments substantially immunize the quality of service from stack-imposed delays, regardless of whether the stack is a constant delay network stack or a variable delay network stack. When the source application-layer packet 510 emerges from the source network stack 520, it is received by the source MAC device 522, in block 610.

Source MAC device 522 produces a MAC packet 530, in block 612. An example of a MAC packet 530 is illustrated in FIG. 5. Packet 530 includes a MAC header 532, the source MAC-layer timestamp 534, the source application-layer timestamp 536, and the source data 538, in one embodiment.

When source MAC device 522 is granted access to the wireless medium (or has determined that the wireless medium is clear of other transmissions), source MAC device 522 passes the MAC packet 530 to a source PHY device (not illustrated in FIG. 5), which processes the MAC packet and transmits it over a device-to-device communication link, in block 614.

Ultimately, the MAC packet 530 is received by a destination PHY device (not illustrated in FIG. 5), in block 616. The destination PHY device processes the MAC packet, and passes it to the destination MAC device 540.

Destination MAC device 540 passes a destination application-layer packet to the destination application 560 via the destination network stack 544, in block 618. The destination network stack 544 may be a constant delay network stack or a variable delay network stack, in various embodiments. FIG. 5 illustrates an example of a destination application-layer packet 550, which includes the source MAC-layer timestamp 552, the source application-layer timestamp 554, and the source data 556, in one embodiment.

Destination application 560 has access to a destination MAC-layer clock 542. In one embodiment, destination application 560 generates a destination transport (i.e., MAC-layer) timestamp, in block 620, by reading clock 542 at approximately a time when the destination application 560 receives the packet 550 from the destination network stack 544.

In addition, destination application 560 has access to a destination application-layer clock 562. In one embodiment, destination application 560 generates a destination application-layer timestamp, in block 622, by reading clock 562 at approximately a time when destination application 560 receives the destination application-layer packet.

Destination application 560 includes a clock recovery process, in one embodiment. In block 624, the clock recovery process 560 calculates a transport delay, in one embodiment. The transport delay is approximately equal to the time difference between the source MAC-layer timestamp and the destination MAC-layer timestamp. The transport delay represents an approximation of the delay imposed by system elements operationally situated between the source application 504 and the destination application 560.

The destination application 560 then performs a clock recovery process, in block 626. In one embodiment, the clock recovery process 560 includes adjusting the source application-layer timestamp with the indicated transport delay before using the source application-layer timestamp for application clock recovery. In one embodiment, clock recovery process 560 subtracts the transport delay from the source application-layer timestamp. Clock recovery process 560 then compares the adjusted source application-layer timestamp with the destination application-layer timestamp, calculates the difference between the two values, and adjusts the destination application-layer clock 562 according to the calculated difference. The method then ends.

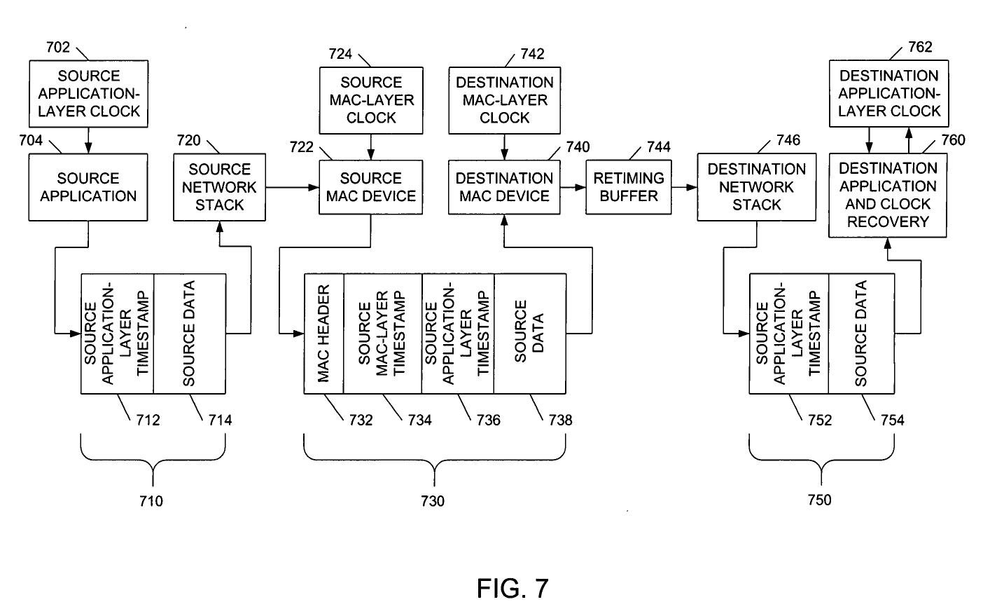

In the embodiments described in conjunction with FIGS. 3-6, the end-to-end delay (i.e., the source application-to-destination application delay) can be completely variable. In other embodiments, described below in conjunction with FIGS. 7-10, the destination device includes a capability (e.g., a retiming buffer) to delay delivery of source data to the destination application until a pre-determined cumulative delay is reached. An advantage to the embodiments described in conjunction with FIGS. 7-10 is that the destination application clock recovery process need not be modified to take into account the transport delay. Instead, the effects of the transport delay are absorbed by the delivery delaying process.

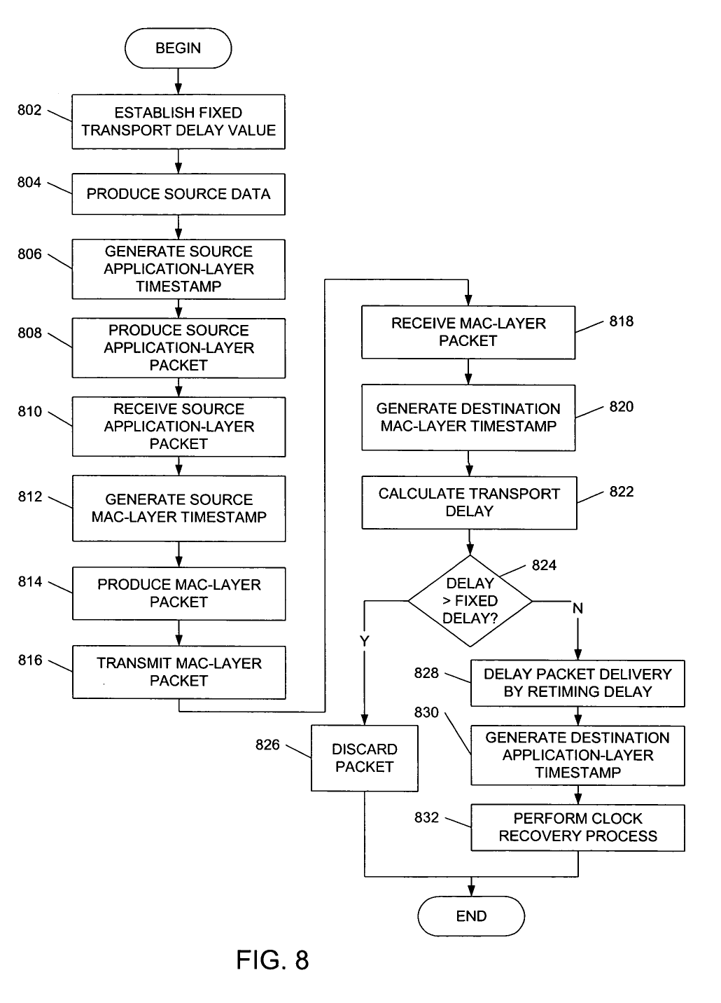

FIG. 7 is a simplified block diagram illustrating packet flow from a source application to a destination application, in accordance with another embodiment of the inventive subject matter. FIG. 7 should be viewed in conjunction with FIG. 8, which is a flowchart of a method for performing clock recovery in a system such as that illustrated in FIG. 7, in accordance with an embodiment of the inventive subject matter.

FIG. 7 will be described from left to right, and descriptions of the various method operations of FIG. 8 will be intertwined with the descriptions of the elements of FIG. 7 and, accordingly, it is suggested that FIGS. 7 and 8 be viewed side-by-side for greater understanding. Also, to aid the reader in following the description, it is noted that elements of FIG. 7 are referred to with reference numerals starting with “7” (e.g., 702, 704, etc.), and operations of FIG. 8 are referred to with reference to numerals starting with “8” (e.g., 802, 804, etc.). Several of the elements and operations of FIGS. 7 and 8 are similar to elements and operations described in conjunction with FIGS. 3-6. Where similarities exist, they will not be extensively repeated for the purposes of brevity.

As briefly mentioned above, a destination device may impose a “retiming delay” on received source data before allowing the data to be delivered to the destination application. As will be described in more detail later, the retiming delay approximately equals a pre-determined source-to-destination delay, referred to herein as a “fixed transport delay,” minus the actual transport delay experienced by the packet.

In one embodiment, the fixed transport delay is established, in block 802 (FIG. 8). In one embodiment, this value is established within the context of a device configuration process. For example, the destination device may receive a control input that indicates the fixed transport delay. In another embodiment, this value may be established through a negotiation or handshaking process between the source device and the destination device. This process may occur once at the beginning of a communication session, for example, or may occur periodically or occasionally during the course of communications between the source and destination devices. The fixed transport delay will be referred to again later in conjunction with operations 822-828. In an alternate embodiment, the delay may be established without negotiation by occasionally or continuously adapting to the longest observed delay, as long as the delay is less than a pre-established delay limit. This process is likely to reach a steady-state, with a relatively stable longest observed delay, within a few seconds of sending and receiving program content.

During a communication session, a source device may execute one or more source applications, such as source application 704 (FIG. 7). Source application 704 produces source data, in block 804.

Source application 704 has access to a source application-layer clock 702. In one embodiment, source application 704 generates a source application-layer timestamp, in block 806, by reading clock 702 at approximately a time when source application 704 produces an application-layer packet, in block 808.

An example of a source application-layer packet 710 is illustrated in FIG. 7. Packet 710 includes a source application-layer timestamp 712 and the source data 714, in one embodiment. The source application-layer timestamp 712 may form a portion of a source application-layer packet header, or timestamp 712 may be placed in a separate field from a header, in various embodiments.

The source application-layer packet 710 is passed through a source network stack 720. The source network stack 320 includes various stack elements, which may impose delays on the source application-layer packet 710.

When the source application-layer packet 710 emerges from the source network stack 720, it is received by the source MAC device 722, in block 810. Source MAC device 722 has access to a source MAC-layer clock 724. In one embodiment, MAC device 722 generates a source transport (e.g., MAC-layer) timestamp, in block 812, by reading clock 724 at approximately a time when MAC device 722 receives the source application layer packet 710.

Source MAC device 722 produces a MAC packet 730, in block 814. An example of a MAC packet 730 is illustrated in FIG. 7. Packet 730 includes a MAC header 732, the source MAC-layer timestamp 734, the source application-layer timestamp 736, and the source data 738, in one embodiment.

When source MAC device 722 is granted access to the wireless medium (or has determined that the wireless medium is clear of other transmissions), source MAC device 722 passes the MAC packet 730 to a source PHY device (not illustrated in FIG. 7), which processes the MAC packet and transmits it over a device-to-device communication link, in block 816.

Ultimately, the MAC packet 730 is received by a destination PHY device (not illustrated in FIG. 7), in block 818. The destination PHY device processes the MAC packet, and passes it to the destination MAC device 740.

The destination MAC device 740 generates a destination transport (e.g., MAC-layer) timestamp, in block 820, from the destination MAC-layer clock 742. In block 822, the destination MAC device 740 calculates a transport delay, in one embodiment. The transport delay is approximately equal to the time difference between the source MAC-layer timestamp and the destination MAC-layer timestamp. The transport delay represents an approximation of the delay imposed by system elements operationally situated between the source MAC device 722 and the destination MAC device 740.

In block 824, a determination is made whether the calculated transport delay is greater than the fixed transport delay (i.e., the fixed transport delay established in block 802). If so, then the packet is discarded, in block 826, as its contents may have been received outside of an acceptable synchronization limit.

If the calculated transport delay is not greater than the fixed transport delay, then the source data is delayed by a retiming delay, in block 828, using a retiming buffer 744 or other delay mechanism. In one embodiment, the retiming delay has a value approximately equal to the fixed transport delay minus the calculated transport delay. In one embodiment, the retiming buffer 744 is configured so that it will deliver the source data to the destination network stack 746 upon expiration of the retiming delay.

Retiming buffer 744 passes a destination application-layer packet 750 to the destination application 760 via the destination network stack 746. The destination network stack 746 may be a constant delay network stack or a variable delay network stack, in various embodiments. FIG. 7 illustrates an example of a destination application-layer packet 750, which includes the source application-layer timestamp 752 and the source data 754, in one embodiment.

Destination application 760 has access to a destination application-layer clock 762. In one embodiment, destination application 760 generates a destination application-layer timestamp, in block 830, by reading clock 762 at approximately a time when destination application 760 receives the destination application-layer packet.

Destination application 760 includes a clock recovery process, in one embodiment. In block 832, the clock recovery process 760 compares the source application-layer timestamp with the destination application-layer timestamp, calculates the difference between the two values, and adjusts the destination application-layer clock 762 according to the calculated difference. The method then ends.

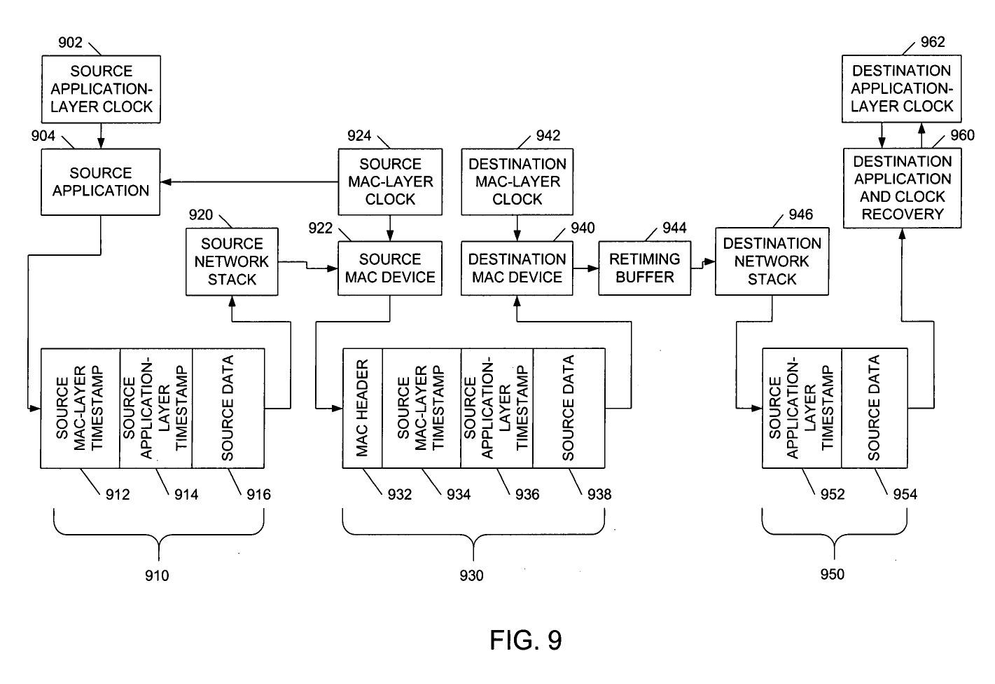

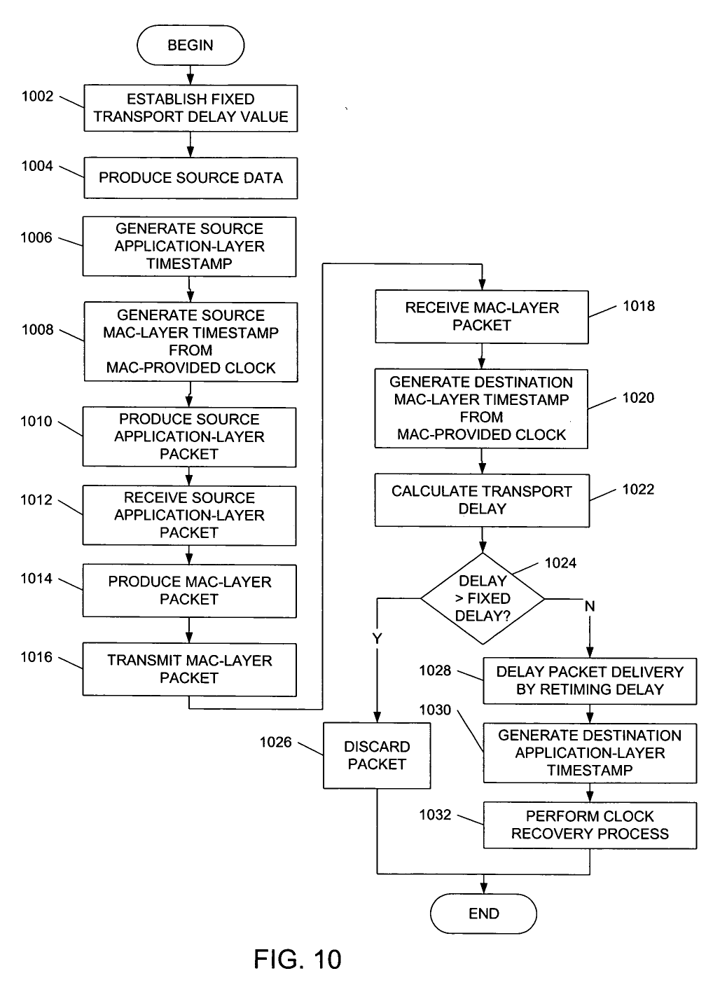

The embodiments described above in conjunction with FIGS. 7 and 8 generate the MAC-layer timestamp (e.g., timestamp 734) when the source data enters the MAC layer. As described previously, the source network stack (e.g., stack 720) may impose a variable delay in addition to the delay caused by other device and system elements. Accordingly, in another embodiment, the MAC-layer timestamp is generated approximately when the source data enters the source network stack, rather than when the source data enters the MAC layer. In addition, the destination device includes a mechanism for delaying the source data by a retiming delay, as was described above. This embodiment is described in conjunction with FIGS. 9 and 10.

FIG. 9 is a simplified block diagram illustrating packet flow from a source application to a destination application, in accordance with another embodiment of the inventive subject matter. (Embodiment 5) FIG. 9 should be viewed in conjunction with FIG. 10, which is a flowchart of a method for performing clock recovery in a system such as that illustrated in FIG. 9, in accordance with an embodiment of the inventive subject matter.

FIG. 9 will be described from left to right, and descriptions of the various method operations of FIG. 10 will be intertwined with the descriptions of the elements of FIG. 9 and, accordingly, it is suggested that FIGS. 9 and 10 be viewed side-by-side for greater understanding. Also, to aid the reader in following the description, it is noted that elements of FIG. 9 are referred to with reference numerals starting with “9” (e.g., 902, 904, etc.), and operations of FIG. 10 are referred to with reference to numerals starting with “10” (e.g., 1002, 1004, etc.). Several of the elements and operations of FIGS. 9 and 10 are similar to elements and operations described in conjunction with FIGS. 3-8. Where similarities exist, they will not be extensively repeated for the purposes of brevity.

Described in conjunction with FIGS. 7 and 8, a destination device may impose a retiming delay on received source data before allowing the data to be delivered to the destination application. In one embodiment, the retiming delay approximately equals a fixed transport delay, minus the actual transport delay experienced by the packet.

In one embodiment, the fixed transport delay is established, in block 1002 (FIG. 10). In various embodiments, this value may be established within the context of a device configuration process, through a negotiation or handshaking process between the source device and the destination device, or using other techniques. The fixed transport delay will be referred to again later in conjunction with operations 1022-1028.

During a communication session, a source device may execute one or more source applications, such as source application 904 (FIG. 9). Source application 904 produces source data, in block 1004.

Source application 904 has access to a source application-layer clock 902. In one embodiment, source application 904 generates a source application-layer timestamp, in block 1006, by reading clock 902 at approximately a time when source application 904 produces an application-layer packet.

In addition, in one embodiment, source application 904 has access to a source MAC-layer clock 924 through an interface between the application layer and the MAC layer. In one embodiment, source application 904 also generates a source transport (e.g., MAC-layer) timestamp, in block 1008, by reading clock 924 at approximately a time when source application 904 submits the source data to the source network stack 920. In one embodiment, source application 904 generates the source MAC-layer timestamp using the same time base as the source MAC-layer clock 924. In another embodiment, source application 904 generates the source MAC-layer timestamp by converting the time reading from the MAC-layer clock 924 into the same time base that is used for the source application-layer clock 902.

Source application 904 produces a source application-layer packet, in block 1010. An example of a source application-layer packet 910 is illustrated in FIG. 9. Packet 910 includes a source MAC-layer timestamp 912, a source application-layer timestamp 914, and the source data 916, in one embodiment. The source MAC-layer timestamp 912 and/or the source application-layer timestamp 914 may form portions of a source application-layer packet header, or timestamps 912 and/or 914 may be placed in separate fields from a header, in various embodiments. If the application-layer packet 910 includes a header, the header may contain fields with other information, as well. However, for ease of illustration, any other information that may be included in a header is omitted from FIG. 9.

The source application-layer packet 910 is passed through a source network stack 920, which includes stack elements that may or may not impose significant delays on the source application-layer packet 910. By generating the source MAC-layer timestamp 912 before the packet 910 incurs these delays, the destination MAC device 940 will be able to consider these delays in determining how long the retiming delay should be, as will be described later. Accordingly, the embodiments described in conjunction with FIGS. 9 and 10 enable the calculated transport delay to encompass more system delay elements that may cause variable delays between the source application and the destination application. When the source application-layer packet 910 emerges from the source network stack 920, it is received by the source MAC device 922, in block 1012.

Source MAC device 922 produces a MAC packet 930, in block 1014. An example of a MAC packet 930 is illustrated in FIG. 9. Packet 930 includes a MAC header 932, the source MAC-layer timestamp 934, the source application-layer timestamp 936, and the source data 938, in one embodiment.

When source MAC device 922 is granted access to the wireless medium (or has determined that the wireless medium is clear of other transmissions), source MAC device 922 passes the MAC packet 930 to a source PHY device (not illustrated in FIG. 9), which processes the MAC packet and transmits it over a device-to-device communication link, in block 1016.

Ultimately, the MAC packet 930 is received by a destination PHY device (not illustrated in FIG. 9), in block 1018. The destination PHY device processes the MAC packet, and passes it to the destination MAC device 940.

The destination MAC device 940 generates a destination transport (e.g., MAC-layer) timestamp, in block 1020, from the destination MAC-layer clock 942. In block 1022, the destination MAC device 940 calculates a transport delay, in one embodiment. The transport delay is approximately equal to the time difference between the source MAC-layer timestamp and the destination MAC-layer timestamp. The transport delay represents an approximation of the delay imposed by system elements operationally situated between the source application 904 and the destination MAC device 940.

In block 1024, a determination is made whether the calculated transport delay is greater than the fixed transport delay (i.e., the fixed transport delay established in block 1002). If so, then the packet is discarded, in block 1026, as its contents may have been received outside of an acceptable synchronization limit.

If the calculated transport delay is not greater than the fixed transport delay, then the source data is delayed by a retiming delay, in block 1028, using a retiming buffer 944 or other delay mechanism. In one embodiment, the retiming delay has a value approximately equal to the fixed transport delay minus the calculated transport delay. In one embodiment, the retiming buffer 944 is configured so that it will deliver the source data to the destination network stack 946 upon expiration of the retiming delay.

Retiming buffer 944 passes a destination application-layer packet 950 to the destination application 960 via the destination network stack 946. The destination network stack 946 may be a constant delay network stack or a variable delay network stack, in various embodiments. FIG. 9 illustrates an example of a destination application-layer packet 950, which includes the source application-layer timestamp 952 and the source data 954, in one embodiment.

Destination application 960 has access to a destination application-layer clock 962. In one embodiment, destination application 960 generates a destination application-layer timestamp, in block 1030, by reading clock 962 at approximately a time when destination application 960 receives the destination application-layer packet.

Destination application 960 includes a clock recovery process, in one embodiment. In block 1032, the clock recovery process 960 compares the source application-layer timestamp with the destination application-layer timestamp, calculates the difference between the two values, and adjusts the destination application-layer clock 962 according to the calculated difference. The method then ends.

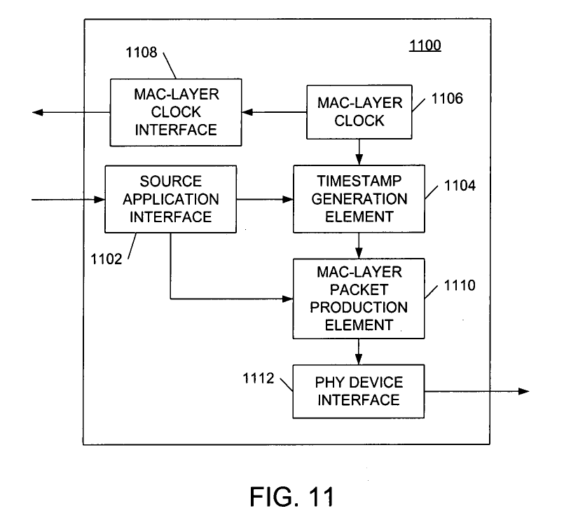

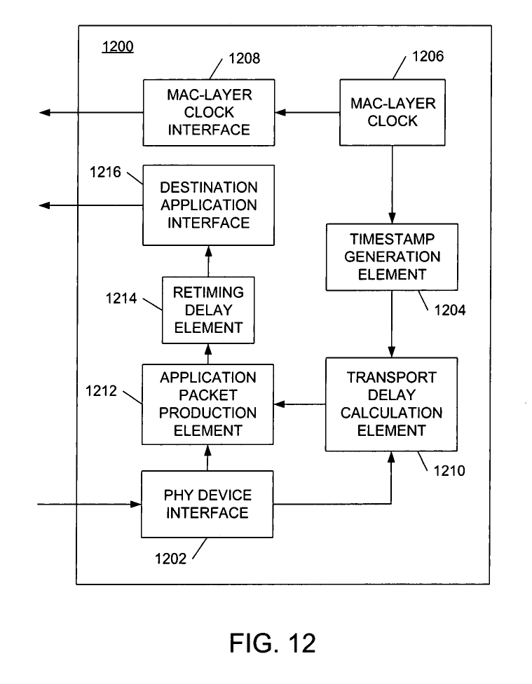

Particular elements of a source MAC device and a destination MAC device to achieve the various embodiments described above. FIGS. 11 and 12 illustrate example block diagrams of a source and destination MAC device, respectively, which could be used to carry out various embodiments of the inventive subject matter. It is to be understood that these block diagrams illustrate only one embodiment, each, of a source and a destination MAC device, and that modifications to these examples may be made by those of skill in the art, in order to achieve the same results in a different way.

FIG. 11 is a simplified block diagram of a source MAC device 1100, in accordance with an embodiment of the inventive subject matter. MAC device 1100 may include a source application interface 1102, a timing generation element 1104, a MAC-layer clock 1106, a MAC-layer clock interface 1108, a MAC packet production element 1110, and a PHY device interface 1112, in various embodiments.

Source application interface 1102 receives an application-layer packet produced by a source application. The application-layer packet includes a source application-layer timestamp and source data. In one embodiment, the application-layer packet also includes a source MAC-layer timestamp.

In another embodiment, the application-layer packet does not include a source MAC-layer timestamp. In such an embodiment, MAC device 1100 also includes a timestamp generation element 1104, which generates the source MAC-layer timestamp in response to receiving the application-layer packet. In one embodiment, the source MAC-layer timestamp is generated based on MAC-layer clock 1106. During operation, the MAC-layer clock 1106 is substantially synchronized with a corresponding MAC-layer clock in a destination device.

In an embodiment where the source application generates the source MAC-layer timestamp (rather than the MAC), values within the MAC-layer clock 1106 may be provided to the source application using MAC-layer clock interface 1108. This interface may be excluded in embodiments where the MAC device generates the source MAC-layer timestamp.

MAC packet production element 1110 produces a MAC packet that includes the source application-layer timestamp, the source data, and the source MAC-layer timestamp. The MAC packet is passed to a PHY device using PHY device interface 1112.

FIG. 12 is a simplified block diagram of a destination MAC device 1200, in accordance with another embodiment of the inventive subject matter. MAC device 1200 may include a PHY device interface 1202, a timestamp generation element 1204, a MAC-layer clock 1206, a MAC-layer clock interface 1208, a transport delay calculation element 1210, an application packet production element 1212, a retiming delay element 1214, and a destination application interface 1216, in various embodiments.

PHY device interface 1202 receives a MAC packet from a PHY device. The MAC packet includes a source MAC-layer timestamp, a source application-layer timestamp, and source data, in one embodiment.

MAC device 1200 also includes a timestamp generation element 1204, in one embodiment, which generates a destination MAC-layer timestamp when the source data is ready to be delivered to the destination application. In one embodiment, the destination MAC-layer timestamp is generated based on MAC-layer clock 1206. The MAC-layer clock 1206 is substantially synchronized with a corresponding MAC-layer clock in a source device, in one embodiment.

In an embodiment where the destination application generates the destination MAC-layer timestamp (rather than the MAC), values within the MAC-layer clock 1206 may be provided to the application using MAC-layer clock interface 1208. This interface may be excluded in embodiments where the MAC device generates the destination MAC-layer timestamp.

In one embodiment, transport delay calculation element 1210 calculates a transport delay applied to the MAC packet based on the received source MAC-layer timestamp (in the MAC packet) and the destination MAC-layer timestamp, if it is generated by the destination MAC device. In another embodiment, the transport delay is calculated by the destination application, and this element 1210 may be excluded.

Application packet production element 1212 produces a destination application packet that includes the source application-layer timestamp and the source data. The application packet may also include the calculated transport delay, in one embodiment, or the destination MAC-layer timestamp, in another embodiment.

In one embodiment, MAC device 1200 also includes retiming delay element 1214, which delays delivery of the destination application-layer packet to the destination application by a retiming delay. In another embodiment, a retiming delay element is located externally MAC device 1200, or excluded from the system altogether. The application packet is passed to a destination application using destination application interface 1216.

The foregoing description of specific embodiments reveals the general nature of the inventive subject matter sufficiently that others can, by applying current knowledge, readily modify and/or adapt it for various applications without departing from the generic concept. Therefore such adaptations and modifications are within the meaning and range of equivalents of the disclosed embodiments. The phraseology or terminology employed herein is for the purpose of description and not of limitation. Accordingly, the inventive subject matter embraces all such alternatives, modifications, equivalents and variations as fall within the spirit and broad scope of the appended claims.

The operations described above, with respect to the methods illustrated and described herein, can be performed in a different order from that disclosed. Also, it will be understood that, although some methods are described as having an “end,” they may be continuously performed.

The various procedures described herein can be implemented in hardware, firmware or software. A software implementation can use microcode, assembly language code, or a higher-level language code. The code may be stored on one or more volatile or non-volatile computer-readable media during execution or at other times. These computer-readable media may include hard disks, removable magnetic disks, removable optical disks, magnetic cassettes, flash memory cards, digital video disks, Bernoulli cartridges, random access memories (RAMs), read-only memories (ROMs), and the like. Accordingly, a computer-readable medium, including those listed above, may store program instructions thereon to perform a method, which when executed within an electronic device, result in embodiments of the inventive subject matter being carried out.

1. A method comprising:
producing a medium access control (MAC) packet that includes a source application-layer timestamp, source data, and a source MAC-layer timestamp, wherein the source MAC-layer timestamp is based on a substantially synchronized clock between a source device and a destination device, and the source MAC-layer timestamp indicates a time when the source data is provided for transmission across a portion of a system that is subject to variable delays.

2. The method of claim 1, further comprising:
receiving an application-layer packet from a source application, wherein the application-layer packet includes the source application-layer timestamp and the source data; and
generating the source MAC-layer timestamp in response to receiving the application-layer packet.

3. The method of claim 2, wherein generating the source MAC-layer timestamp comprises:
generating the source MAC-layer timestamp when the application-layer packet enters a medium access control layer of the source device.

4. The method of claim 1, further comprising:
receiving an application-layer packet from a source application, wherein the application-layer packet includes the source application-layer timestamp, the source data, and the source MAC-layer timestamp.

5. The method of claim 4, further comprising:
providing access to the substantially synchronized clock to the source application.

6. The method of claim 1, further comprising:
establishing a fixed transport delay value for the destination device to use to schedule delivery of the source data to a destination application.

7. The method of claim 6, wherein determining the delay value comprises:
performing a negotiation process between the source device and the destination device to determine the fixed transport delay value.

8. The method of claim 6, wherein determining the delay value comprises:
determining a longest observed delay between the source device and the destination device to determine the fixed transport delay value.

9. The method of claim 1, further comprising:
transmitting the MAC packet toward the destination device.

10. The method of claim 1, wherein the source device is a wireless local area network communications device, and wherein producing the MAC packet is performed by a medium access control device of the source device.

11. A method comprising:
calculating a transport delay experienced by a medium access control (MAC) packet due to a variable delay between a source device and a destination device, wherein the MAC packet includes a source MAC-layer timestamp, a source application-layer timestamp, and source data, and the transport delay is calculated based on the source MAC-layer timestamp and a destination MAC-layer timestamp generated based on a substantially synchronized clock between the source device and the destination device.

12. The method of claim 11, further comprising:
a destination application using the transport delay and the source application-layer timestamp to perform an application clock recovery process.

13. The method of claim 11, further comprising:
generating a destination MAC-layer timestamp, which indicates an approximate time when the source data is ready to be provided to a destination application, wherein the destination MAC-layer timestamp is based on the substantially synchronized clock, and the destination MAC-layer timestamp and the source MAC-layer timestamp are used in calculating the transport delay.

14. The method of claim 11, further comprising:
establishing a fixed transport delay value for the destination device to use to schedule delivery of the source data to a destination application; and
delaying delivery of the MAC packet to the destination application by a retiming delay, which is approximately equal to the fixed transport delay value minus the transport delay.

15. The method of claim 14, further comprising:
discarding the source data if the transport delay exceeds the fixed transport delay value.

16. The method of claim 14, wherein establishing the fixed transport delay value comprises:
performing a negotiation process between the source device and the destination device to determine the fixed transport delay value.

17. The method of claim 14, wherein establishing the fixed transport delay value comprises:
determining a longest observed delay between the source device and the destination device to determine the fixed transport delay value.

18. The method of claim 11, further comprising:
providing access to the substantially synchronized clock to the destination application, to enable the destination application to calculate the destination transport delay and to perform a clock recovery process.

19. The method of claim 11, wherein the destination device is a wireless local area network communications device, and wherein calculating the transport delay is performed by a medium access control element of the destination device.

20. A method comprising:
producing, by a source device, a medium access control (MAC) packet that includes a source application-layer timestamp, source data, and a source MAC-layer timestamp, wherein the source MAC-layer timestamp is based on a substantially synchronized clock between the source device and a destination device, and the source MAC-layer timestamp indicates a time when the source data is provided for transmission across a portion of a system that is subject to variable delays;
transmitting the MAC packet from the source device to the destination device; and
calculating, by the destination device, a transport delay applied to the MAC packet based on the source MAC-layer timestamp and a destination MAC-layer timestamp generated based on the substantially synchronized clock.

21. The method of claim 20, further comprising:
establishing a fixed transport delay value for the destination device to use to schedule delivery of the source data to a destination application; and
the destination device delaying delivery of the source data to the destination application by a retiming delay that is approximately equal to the fixed transport delay value minus the transport delay.

22. The method of claim 20, further comprising:
generating a destination MAC-layer timestamp, which indicates an approximate time when the source data is ready to be provided to a destination application, wherein the destination MAC-layer timestamp is based on the substantially synchronized clock, and the destination MAC-layer timestamp and the source MAC-layer timestamp are used in calculating the transport delay.

23. An apparatus comprising:
a medium access control (MAC) packet production element, which produces a MAC packet that includes a source application-layer timestamp, source data, and a source MAC-layer timestamp, wherein the source MAC-layer timestamp is based on a substantially synchronized clock between a source device and a destination device, and the source MAC-layer timestamp indicates a time when the source data is provided for transmission across a portion of a system that is subject to variable delays; and
a clock that is capable of being used as the substantially synchronized clock.

24. The apparatus of claim 23, further comprising:
a source application interface, which receives an application-layer packet from a source application, wherein the application-layer packet includes the source application-layer timestamp and the source data; and
a timestamp generation element, which generates the source MAC-layer timestamp in response to receiving the application-layer packet.

25. The apparatus of claim 23, further comprising:
a source application interface, which receives an application-layer packet from a source application, wherein the application-layer packet includes the source application-layer timestamp, the source data, and the source MAC-layer timestamp.

26. The apparatus of claim 23, further comprising:
a clock interface, which enables the substantially synchronized clock to be provided to a source application.

27. The apparatus of claim 23, wherein the apparatus forms a portion of a wireless local area network device, and the apparatus further comprises:
an antenna for transmitting the MAC packet over a device-to-device communication link.

28. An apparatus comprising:
a transport delay calculation element, which calculates a transport delay applied to a medium access control (MAC) packet, wherein the MAC packet includes a source MAC-layer timestamp, a source application-layer timestamp, and source data, and the transport delay is calculated based on the source MAC-layer timestamp and a substantially synchronized clock between the source device and the destination device; and
a clock that is capable of being used as the substantially synchronized clock.

29. The apparatus of claim 28, further comprising:
a destination MAC-layer timestamp generation element, which generates a destination MAC-layer timestamp that indicates an approximate time when the source data will be provided to a destination application, wherein the destination MAC-layer timestamp is based on the substantially synchronized clock, and the destination MAC-layer timestamp and the MAC-layer timestamp are used in calculating the transport delay.

30. The apparatus of claim 28, further comprising:
a fixed transport delay element, which delays delivery of the source data to a destination application by a retiming delay that is approximately equal to a fixed transport delay value minus the transport delay.

31. The apparatus of claim 28, further comprising:
a clock interface, which enables the substantially synchronized clock to be provided to a destination application.

32. The apparatus of claim 28, wherein the apparatus forms a portion of a wireless local area network device, and the apparatus further comprises:
an antenna for receiving the MAC packet over an air interface.

33. A computer-readable medium having program instructions stored thereon to perform a method, which when executed within an electronic device, result in:
producing a medium access control (MAC) packet that includes a source application-layer timestamp, source data, and a source MAC-layer timestamp, wherein the source MAC-layer timestamp is based on a substantially synchronized clock between a source device and a destination device, and the source MAC-layer timestamp indicates a time when the source data is provided for transmission across a portion of a system that is subject to variable delays.

34. The computer-readable medium of claim 33 wherein execution of the method further results in:
receiving an application-layer packet from a source application, wherein the application-layer packet includes the source application-layer timestamp and the source data; and
generating the source MAC-layer timestamp in response to receiving the application-layer packet.

35. The computer-readable medium of claim 33, wherein execution of the method further results in:
receiving an application-layer packet from a source application, wherein the application-layer packet includes the source application-layer timestamp, the source data, and the source MAC-layer timestamp.

36. The computer-readable medium of claim 33, wherein execution of the method further results in:
providing access to the substantially synchronized clock to the source application.

37. A computer-readable medium having program instructions stored thereon to perform a method, which when executed within an electronic device, result in:
calculating a transport delay experienced by a medium access control (MAC) packet due to a variable delay between a source device and a destination device, wherein the MAC packet includes a source MAC-layer timestamp, a source application-layer timestamp, and source data, and the transport delay is calculated based on the source MAC-layer timestamp and a destination MAC-layer timestamp generated based on a substantially synchronized clock between the source device and the destination device.

38. The computer-readable medium of claim 37, wherein execution of the method further results in:
generating a destination MAC-layer timestamp, which indicates an approximate time when the source data is ready to be provided to a destination application, wherein the destination MAC-layer timestamp is based on the substantially synchronized clock, and the destination MAC-layer timestamp and the source MAC-layer timestamp are used in calculating the transport delay.

39. The computer-readable medium of claim 37, wherein execution of the method further results in:
establishing a fixed transport delay value for the destination device to use to schedule delivery of the source data to a destination application; and
delaying delivery of the MAC packet to the destination application by a retiming delay, which is approximately equal to the fixed transport delay value minus the transport delay.

40. The computer-readable medium of claim 37, wherein execution of the method further results in:
providing access to the substantially synchronized clock to the destination application, to enable the destination application to calculate the transport delay and to perform a clock recovery process.
